(19) United States
(12) Patent Application Publication
(10) Pub. No.: US 2003/0017251 A1
(43) Pub. Date: Jan. 23, 2003

(54) Novel roasted coffee with a balanced flavor and a process for making it

(76) Inventors: Steven Jacob Kirkpatrick, Cincinnati, OH (US); Dana Lynn Bridge, Cincinnati, OH (US); Michelle Carolyn Faber, West Chester, OH (US); William Michael Davis, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/204,748

(22) PCT Filed: Mar. 13, 2001
(86) PCT No.: PCT/US01/07997

(51) Int. Cl. A23F 5/00

(52) U.S. Cl. 426/595

(57) ABSTRACT

This invention provides a novel coffee blend and a process for making said novel coffee. This novel coffee contains both a “faster-roast fraction” and a “slower-roast fraction”. The “faster-roast fraction” contributes no less than 20% and no more than 80% to the 100% coffee blend, preferably no less than 30% and no more than 70% to the coffee blend, and more preferably, no less than 40% and no more than 60% to the coffee blend. Similarly, the “slower-roast fraction” contributes no less than 20% and no more than 80% to the 100% coffee blend, preferably no less than 30% and no more than 70% of the coffee blend, and more preferably, no less than 40% and no more than 60% of the coffee blend. Any 100% coffee blend where the “faster-roast fraction” and the “slower-roast fraction” in combination contribute a minimum of 70% of the 100% total is covered herein. Said “faster-roast fraction” has been roasted for a time period of about 1X to about 3.5 X and said “slower-roast fraction” has been roasted for a time period of from about 4.5X to about 6X, wherein the value of X is constant within each 100% coffee blend. X is greater than or equal to one (1) minute, preferably from about one (1) minute to about four (4) minutes, more preferably from about one (1) minute to about three (3) minutes, most preferably from about one (1) minute to about two (2) minutes. In the process of the present invention, each fraction consists of one or more independently roasted streams, each with the same or different roast times and/or the same or different target Hunter-L colors and/or the same or different coffee types, as long as the roast time of each stream falls within the specified time range where X is constant for a given 100% coffee blend. The faster-roast fraction, the slower-roast fraction, and any other streams are blended after roasting.

### CROSS REFERENCE TO RELATED APPLICATION

This application claims the benefit of priority to U.S. Provisional Application Serial No. 60/188,987, filed Mar. 13, 2000, which is herein incorporated by reference.

### FIELD OF INVENTION

The present invention relates to novel roasted coffee with balanced flavor and a process for making it.

### BACKGROUND OF THE INVENTION

Attempts have been made in the past to make roasted coffee exhibiting a balanced flavor with some of the body observed in faster-roasted coffees and some of the character that tends to develop in slower-roasted coffees. Faster-roasted coffees generally have a lower perceived acidity and more body, a flavor desired by some consumers. Slower-roasted coffees tend to develop a more distinctive character during the roasting process and typically have a crisp, higher perceived acidity. This flavor is considered desirable by many consumers as well. When faster and slower-roast fractions are mixed through blend after roast, the flavor profile is rounded out, resulting in an unusually balanced flavor, where the coffee flavor is allowed to come through more effectively. Additionally, this process maintains some of the body observed in faster-roasted coffees and some of the character developed in slower-roasted coffees, both desirable coffee attributes. The result is the ability to develop unique coffees with high consumer acceptance.

There is therefore a need to provide a roasted coffee that is cost effective in that it allows the flexibility to formulate the blend with readily available beans and also exhibits a balanced flavor with improved body and a distinctive character.

### SUMMARY OF THE INVENTION

This invention provides a novel coffee blend and a process for making said novel coffee. This novel coffee contains both a “faster-roast fraction” and a “slower-roast fraction”. The “faster-roast fraction” contributes no less than 20% and no more than 80% to the 100% coffee blend, preferably no less than 30% and no more than 70% to the coffee blend, and more preferably, no less than 40% and no more than 60% to the coffee blend. Similarly, the “slower-roast fraction” contributes no less than 20% and no more than 80% to the 100% coffee blend, preferably no less than 30% and no more than 70% of the coffee blend, and more preferably, no less than 40% and no more than 60% of the coffee blend. Any 100% coffee blend where the “faster-roast fraction” and the “slower-roast fraction” in combination contribute a minimum of 70% of the 100% total is covered herein. Said “faster-roast fraction” has been roasted for a time period of about 1X to about 3.5 X and said “slower-roast” fraction has been roasted for a time period of about 4.5X to about 6X, wherein the value of X is constant within each 100% coffee blend. X is greater than or equal to one (1) minute, preferably from about one (1) minute to about four (4) minutes, more preferably from about one (1) minute to about three (3) minutes, most preferably from about one (1) minute to about two (2) minutes. The faster-roast fraction may consist of multiple independently roasted streams, each with the same or different roast times and/or the same or different target Hunter L-colors and/or the same or different coffee types, as long as the roast time of each stream falls within the time period 1X to 3.5X, inclusive, where X is constant for a given 100% coffee blend. Likewise, the slower-roast fraction may consist of multiple independently roasted streams, each with the same or different roast times and/or the same or different target Hunter-L colors and/or the same or different coffee types, as long as the roast time of each stream falls within the time period 4.5X to 6X, inclusive, where X is constant for a given 100% coffee blend. The faster-roast fraction and the slower-roast fraction, and any streams which make up either or both fractions are blended after roasting.

The novel coffee according to the present invention has a unique flavor profile that combines the desirable attributes of coffees with unique roast times to achieve a balanced flavor profile. This profile cannot be achieved using any individual stream at either of the unique roast times or with any roast time in between. The shortcomings of each stream's flavor profile are tempered by blending such than the undesirable flavors of each are less obvious and the desirable flavors still come through. Many consumers find this novel flavor profile desirable.

Also, in particularly preferred embodiments of the present invention, to achieve the desired balanced flavor profile, it is preferable that the Hunter L-color differential between any slower fraction stream and any faster fraction stream are small. Any slower-roast stream is preferably between 2L lighter and 2L darker than any 100% Arabica faster-roast stream, inclusive. Any slower-roast stream is preferably between 4L and 7L darker than any faster-roast stream containing 50% or more Robusta type beans. The slower roasted streams may each be anywhere from 2L lighter to 7L darker than a faster-roast stream containing Robusta type beans in any quantity below 50%. Large roast color differentials negatively impact the balanced flavor provided by the novel process described herein.

The invention is a roasted coffee with balanced flavor and a process for making it. A portion of the beans are slow-roast to a target roast time between 270 and 1400 seconds to a target Hunter L-color, typically 21-11L. The faster-roast portion of the coffee beans are roasted between 60 and 720 seconds to a target Hunter L-color, typically 21-11L if 100% Arabica, and typically 24-16L if the stream contains 100% -Robusta type beans. Any stream containing a mixture of both Arabica and Robusta may have a target Hunter L-color anywhere from 24-11L. The novel coffee is a blend after roast containing significant contributions from both the slower and the faster fractions. For example, a two stream coffee blend is preferably comprised of approximately 40 to 60% of a faster-roast stream and 40 to 60% of a slower-roast stream, combined to total 100% of the final coffee blend. It is preferable from a “balanced” taste standpoint for the slower-roast and faster-roast fractions to represent relatively equal contributions to the final blend, preferably neither fraction contributing in excess of 30% more than the other fraction to the final blend. Additionally, the slower-roast and faster-roast fractions should together comprise a majority of the blend, representing at least 70%, more preferably 85% and most preferably 100% of the 100% coffee blend. For example, the faster-roast fraction may comprise 35% and the slower-roast fraction may comprise 35% of the 100% coffee blend where the remaining 30% is comprised of a stream or streams which cannot be made to fall within the definition of “slower-roast” or “faster-roast” streams for the blend in question, where X is a constant for the final 100% coffee blend. The additional 0 to 30% which does not fall within the definition of either “faster-roast” or “slower-roast” for a given blend allows for flexibility and cost savings in developing blends.

### Definitions

The terms used herein have the following definitions:

The term “faster-roast fraction,” as used herein, refers to coffee beans that have been roasted for a period of about 60 seconds to 12 minutes in a conventional roaster, at temperatures of between about 350° F. and 1200° F., preferably between 350° F. and 800° F. Additionally, the roast time must fall within 1X to 3.5X inclusive where X is defined as a constant for a given 100% coffee blend equal to at least 1 minute, preferably from 1 to 4 minutes, more preferably from 1 to 3 minutes, and most preferably from 1 to 2 minutes. Said fraction may be made up of multiple coffee streams roasted to different or identical roasting times, different or identical Hunter-L colors and using different or identical bean types. For example, where X is a constant equal to 1 minute, each of the faster-roast streams may have a roast time anywhere from 1 minute to 3.5 minutes, inclusive.

The term “slower-roast fraction,” as used herein, refers to coffee beans that have been roasted for a period of about 4.5 minutes to about 18 minutes in a conventional roaster, at temperatures of between about 350° F. and 1200° F., preferably between 350° F. and 800° F. Additionally, the roast time must fall within 4.5X to 6X inclusive where X is defined as a constant for a given 100% coffee blend equal to at least 1 minute, preferably from 1 to 4 mnutes, more preferably from 1 to 3 minutes, and most preferably from 1 to 2 minutes. Said fraction may be made up of multiple coffee streams roasted to different or identical roasting times, different or identical Hunter-L colors and using different or identical bean types. For example, where X is a constant equal to 1 minute, each of the slower-roast streams may have a roast time anywhere from 4.5 minutes to 6 minutes, inclusive.

The term “conventional roasting” includes roasting temperatures from about 350° F. to about 1200° F., preferably about 350° F. to 800° F. Roaster types used for conventional roasting include, but are not limited to, batch roasters such as a Thermalo batch roaster, a Probat batch roaster, and a Neotec batch roaster, and continuous roasters such as a Probat continuous roaster and a Neotec continuous roaster.

All ratios and percentages as used herein are based on weight unless stated otherwise.

### DETAILED DESCRIPTION OF THE INVENTION

This invention provides a novel coffee blend and a process for making said novel coffee. This novel coffee contains both a “faster-roast fraction” and a “slower-roast fraction”. The “faster-roast fraction” contributes no less than 20% and no more than 80% to the 100% coffee blend, preferably no less than 30% and no more than 70% of the coffee blend, and more preferably, no less than 40% and no more than 60% of the coffee blend. Similarly, the “slower-roast fraction” contributes no less than 20% and no more than 80% to the 100% coffee blend, preferably no less than 30% and no more than 70% to the coffee blend, and more preferably, no less than 40% and no more than 60% to the coffee blend. Any 100% coffee blend where the “faster-roast fraction” and the “slower-roast fraction” in combination contribute a minimum of 70% of the 100% total is covered herein. Said “faster-roast fraction” has been roast for a time period of about 1X to about 3.5 X and said “slower-roast” fraction has been roasted for a time period of about 4.5X to about 6X, wherein the value of X is constant within each 100% coffee blend. X is greater than or equal to one (1) minute, preferably from about one (1) minute to about four (4) minutes, more preferably from about one (1) minute to about three (3) minutes, most preferably from about one (1) minute to about two (2) minutes. The faster-roast fraction may consist of multiple independently roasted streams, each with the same or different roast times and/or the same or different target Hunter L-colors and/or the same or different coffee types, as long as the roast time of each stream falls within the time period 1X to 3.5X, inclusive, where X is constant for a given 100% coffee blend. Likewise, the slower-roast fraction may consist of multiple independently roasted streams, each with the same or different roast times and/or the same or different coffee types, as long as the roast time of each stream falls within the time period 4.5X to 6X, inclusive, where X is constant for a given 100% coffee blend. The faster-roast fraction and the slower-roast fraction, and any streams which make up either or both fractions are blended after roasting.

A) The Coffee Blend Product

1) The Fractions

The Coffee Blend Product of the present invention is made up of from about 20 to 80% of a faster-roast fraction, and from about 20 to 80% of a slower-roast fraction. Each fraction may be made up of multiple streams of unique or identical varietal compositions and the different streams may have different or identical roast times and Hunter L-colors. It is preferable that there are no more than 5, more preferably no more than about 3, even more preferably no more than about 2, and most preferably no more than about 1, different streams in each of the slower-roast fraction and the faster-roast fraction. Up to 30% of the 100% coffee product may contain a stream or streams cannot fall within the definition of either the “fasterroast” or the “slower-roast” fractions for any value of X, where X is a constant with a value of from about 1 to about 4, inclusive, for a given 100% coffee product.

2) The Coffee Blend

Both the faster- and slower-roast beans can be derived from low, intermediate or high quality coffee beans, or mixtures thereof. The slow-roast beans are preferably derived from intermediate or high quality beans or mixtures thereof. As used herein, non-limiting examples of high quality coffee beans include “Milds” (high grade Arabicas) such as Colombians, Mexicans, and washed Milds such as strictly hard bean Costa Rica, Kenyas A and B, and strictly hard bean Guatemalans. As used herein, non-limiting examples of intermediate quality coffee beans include Brazilians and African naturals. As used herein, non-limiting examples of low quality coffee beans include Robustas, low grade Naturals, low grade Brazils, and low grade unwashed Arabicas.

The coffee blends of the present invention may be whole beans, ground or ground and noramlized to a median particle diameter between about 600 and 100 μm, or ground and milled, or ground, noramlized and milled to an average flake thickness from about 102 to about 1016 μm. Flaked coffee is described in U.S. Pat. Nos. 5,064,676; 4,331,696, 4,267,200; 4,110,485; 3,660,106; 3,652,293; and 3,615,667, all of which are incorporated by reference herein.

B) Process of the Present Invention

The process of the invention involves three key steps. A first step involves slow-roasting the beans to a target Hunter L-color between about 21 and 11L. A second step involves fast-roasting the beans to a target Hunter L-color between about 21 and 11L if 100% Arabica type beans, and between 24 and 16L if the stream contains 100% Robusta type beans. Any stream containing a mixture of both Arabica and Robusta may have a target Hunter L-color anywhere from 24-11L. A third step involves blending the faster-roast and slower-roast fractions, as well as any other stream or streams which contribute to the 100% coffee blend. Each fraction or stream can be blended in any order or combination. Grinding is another aspect which is optional and which may be done before or after blending any of the fractions, or streams which comprise these fractions.

1) Slow-Roasting Coffee Beans

In the slow-roasting step, the beans are roasted to a target Hunter L-color from about 21 to 11L. Conventional roasting methods are used. Roasting temperatures are from about 350° F. to about 1200° F., preferably about 350° F. to 800° F. Roast times are from about 4.5 to 24 minutes, preferably 5 to 15 minutes. At the desired Hunter L-color, the slower-roast beans are removed from the roaster heat. The beans are promptly cooled by typically ambient air and/or a water spray. Cooling the beans stops roast-related pyrolysis reactions.

It has been found that slower-roast beans have higher perceived acidity than faster-roast beans, and slower-roast beans often develop a more unique character than faster-roast beans.

2) Fast-Roasting Coffee Beans

In the fast-roasting step, the beans are roasted to a target Hunter L-color from about 21 to 11L if the stream is 100% Arabica and 24 to 16L if the stream contains 100% Robusta type beans. Any stream containing a mixture of both Arabica and Robusta may have a target Hunter L-color anywhere from 24 to 11L. Conventional roasting methods are used. Roasting temperatures are from about 350° F. to about 1200° F., preferably about 350° F. to 800° F. Roast times are from about 0.5 to 12 minutes, preferably 0.5 to 5 minutes. At the desired Hunter L-color, the faster-roast beans are removed from the roaster heat. The beans are promptly cooled by typically ambient air and/or a water spray. Cooling the beans stops roast-related pyrolysis reactions.

3) Blending the Fractions and Streams

The fast-roast coffee fraction, slow-roast coffee fraction, and any additional streams are blended together. Faster-roast coffees contribute body to the coffee product and slower-roast coffees contribute a more distinctive character. Combined, the slower-roast fraction and faster-roast fraction provide a surprisingly balanced flavor. The faster-roast fraction contributes no less than 20% and no more than 80% to the 100% coffee blend, preferably no less than 30% and no more than 70% of the coffee blend, and more preferably, no less than 40% and no more than 60% of the coffee blend. Likewise, the slower-roast fraction contributes no less than 20% and no more than 80% to the 100% coffee blend, preferably no less than 30% and no more than 70% of the coffee blend, and more preferably, no less than 40% and no more than 60% of the coffee blend. The slower-roast and faster-roast fractions combined must contribute a minimum of 70% to the 100% coffee blend. The coffee may be whole bean, or may before, after, or concurrently with blending, be ground or crack normalized. Then ground mixing can occur.

C) Roast Colors of Coffee Beans

The Hunter color scale system defines the color of coffee beans and the degree to which they have been roasted. The Hunter color scale system is described in an article by R. S. Hunter, “Photoelectric Color Difference Meter,” Journal of the optical society of America, 48, 985-95 (1958), and in U.S. Pat. No. 3,003,388 to Hunter et al., issued Oct. 10, 1961. Both references are incorporated herein by reference.

A complete technical description of the system can be found in an article by R. S. Hunter “Photoelectric Color Difference Meter,” J. of the Optical Soc. of Amer., 48, 985-95 (1958). A Hunter Colorimeter (D25 DP9000 series) is used to measure the lightness/darkness of powders, including coffee. An optical sensor light from a quartz halogen cycle lamp is directed at the sample at a 45° angle from the perpendicular. The reflected light is then collected in a receptor located directly above the sample at 0° angle from the perpendicular. The amount of reflected light is used to determine the lightness of the sample as indicated on the above-described “L” scale. In general, the Hunter Color “L” scale values are units of light reflectance measurement, and the higher the value is, the lighter the color is since a lighter colored material reflects more light. In particular, in the Hunter Color system the “L” scale contains 100 equal units of division; absolute black is at the bottom of the scale (L=0) and absolute white is at the top (L=100). Thus, in measuring degrees of roast, the lower the “L” scale value the greater the degree of roast, since the greater the degree of roast, the darker is the color of the roasted bean. The L scale was developed by Hunter Labs and is based on the internationally accepted measure for lightness. The L value is calculated by the formula:

L=100\sqrt{Y}

where Y is the lightness function of the CIE Tristimulus XYZ Values. CIE is the Commission Internationale de I'Eclairage or the International Commission on Illumination. (Hunter Colorimeter User's Manual for D25 DP-9000 Series, Manual Version 1.4, April 1993, Hunter Associates Laboratory, Reston, Va.)

### EXAMPLES

Preparation and characteristics of the balanced-flavor coffee is illustrated by the following examples.

### Example 1

Batch A (faster-roast fraction): 100% fine South American, high grade Arabica type beans, from Colombia roasted in a Thermalo roaster, Model Number 23R using 45 kg (200 lb) batches. The gas burner input rate is 1.7 million Btu/hr (498 kW). The roasting time is 240 seconds. The roasted beans have a target Hunter L-color of 16.

Batch B (slower-roast fraction): 100% fine South American, high grade Arabica type beans, from Colombia roasted in a Thermalo roster using 45 kg (300 lb) batches. The gas burner input rate is 1.4 million Btu/hr (410 kW). Roasting time is 480 seconds. The roasted beans have a target Hunter L-color of 15.

The Hunter L-color of Batch B is 0 to 2L darker than Batch A, preferably 1L. A 60:40 blend (Batch A to Batch B) is cracked, normalized, and ground to an average particle size of approximately 900 microns.

### Example 2

Batch A (faster-roast fraction): A blend of green washed Arabicas from Mexico and Costa Rica roasted in a Thermalo roaster, Model Number 23R using 45 kg (200 lb) batches. The gas burner input rate is 1.7 million Btu/hr (498 kW). The roasting time is 300 seconds. The roasted beans have a target Hunter L-color of 18.

Batch B (slower-roast fraction): A blend of 65% fine washed Arabica and Colombian, and 35% natural Arabica, low acidity type beans from Honduras and El Salvador. Beans are roasted in a Thermalo roster using 45 kg (500 lb) batches. The gas burner input rate is 1.4 million Btu/hr (410 kW). Roasting time is 900 seconds. The roasted beans have a target Hunter L-color of 18.

The Hunter-L color of Batch B is 1L lighter to 1L darker than Batch A, but preferably the same L-color. A 50:50 blend (Batch A to Batch B) is cracked, normalized, and ground to an average particle size of approximately 600 microns.

### Example 3

Batch A (faster-roast stream): 100% fine South American coffees from Brazil roasted in a Thermalo roaster, Model Number 23R using 45 kg (100 lb) batches. The gas burner input rate is 1.7 million Btu/hr (498 kW). The roasting time is 90 seconds. The roasted beans have a target Hunter L-color of 15.6.

Batch B (faster-roast stream): A blend of Arabicas from Central America and South America roasted in a Thermalo roaster using 45 kg (100 lb) batches. The gas burner input rate is 1.4 million Btu/hr (410 kW). Roasting time is 180 seconds. The roasted beans have a target Hunter L-color of 16.1.

Batch C (slower-roast stream): 100% Indonesian coffee roasted in a Thermalo roster using 45 kg (100 lb) batches. The gas burner input rate is 1.4 million Btu/hr (410 kW). Roasting time is 300 seconds. The roasted beans have a target Hunter L-color of 14.1.

Batch D (slower-roast stream): 100% Indonesian coffee roasted in a Thermalo roster using 45 kg (100 lb) batches. The gas burner input rate is 1.4 million Btu/hr (410 kW). Roasting time is 300 seconds. The roasted beans have a target Hunter L-color of 17.6.

The faster-roast fraction is made up of Batch A stream and Batch B stream. The slower-fraction is made up of Batch C stream and Batch D stream.

The Hunter L-color of Batch C is 0.5 to 2.5L darker than Batch A, preferably 1.5L darker, and Batch C is 1 to 3L darker than Batch B, preferably 2L darker. The Hunter L-color of Batch D is 1 to 3L lighter than Batch A, preferably 2L lighter, and Batch D is 0.5 to 2.5L lighter than Batch B, preferably 1.5L lighter. A 15:25:35:25 blend (Batch A to Batch B to Batch C to Batch D) is cracked, normalized, and ground to an average particle size of approximately 800 microns.

### Example 4

Batch A (faster-roast fraction): 100% Robusta coffees from Vietnam roasted in a Thermalo roaster, Model Number 23R using 45 kg (100 lb) batches. The gas burner input rate is 1.7 million Btu/hr (498 kW). The roasting time is 90 seconds. The roasted beans have a target Hunter L-color of 21.5.

Batch B (slower-roast fraction): A blend of Arabicas from Central America and South America roasted in a Thermalo roster using 45 kg (100 lb) batches. The gas burner input rate is 1.4 million Btu/hr (410 kW). Roasting time is 300 seconds. The roasted beans have a target Hunter L-color of 17.

The Hunter L-color of Batch B is 3.5 to 5.5L darker than Batch A, preferably 4.5L darker. A 30:70 blend (Batch A to Batch B) is cracked, normalized, and ground to an average particle size of approximately 750 microns.

### Example 5

Batch A (faster-roast fraction): 100% Indonesian coffee roasted in a Thermalo roaster using 45 kg (300 lb) batches. The gas burner input rate is 1.4 million Btu/hr (410 kW). Roasting time is 720 seconds. The roasted beans have a target Hunter L-color of 19.

Batch B (slower-roast fraction): 100% fine South American, high grade Arabica type beans from Costa Rica roasted in a Thermalo roaster using 45 kg (500 lb) batches. The gas burner input rate is 1.4 million Btu/hr (410 kW). Roasting time is 1080 seconds. The roasted beans have a target Hunter L-color of 18.

Batch C (Additional stream): 100% coffees from Brazil roasted in a Thermalo roaster, Model Number 23R using 45 kg (100 lb) batches. The gas burner input rate is 1.7 million Btu/hr (498 kW). The roasting time is 120 seconds. The roasted beans have a target Hunter L-color of 22.

The Hunter L-color of Batch B is 0 to 2L darker than Batch A, preferably 1L darker. A 30:40:30 mix (Batch A to Batch B to Batch C) is blended and packed as whole beans.

### Example 6

Batch A (faster-roast fraction): Washed Arabicas from Colombian were fast-roasted on a Probat R72500SY Continuous Roaster with a roast time of 120 seconds. A hot air temperature of 635° F. (335° C.) achieving a roast color of 17.1 L.

Batch B (slower-roast fraction): Washed Arabicas from Guatemala were fast-roasted on a Thermalo roaster Model Number 23R using 45 kg (100 lb) batches. The gas burner input rate is 1.4 million Btu/hr (410 kW). Roasting time is 700 seconds. The roasted beans have a target Hunter L-color of 18.3L.

The Hunter L-color of Batch B is 0.2 to 2.2L lighter than Batch A, preferably 1.2L lighter. A 50:50 blend (Batch A to Batch B) is cracked, normalized, and ground to an average particle size of approximately 800 microns.

What is claimed is:

1. A novel roasted ground or whole bean coffee product comprising:
a) from about 20% to 80% of a faster-roast fraction;
b) from about 20% to 80% of a slower-roast fraction;
c) optionally, no more than about 30% of stream falls outside the definition of a faster or slower-roasted fraction for a given 100% coffee blend

2. A novel roasted and ground or whole bean coffee product wherein said faster-roast fraction
a) is roasted for a time period of 1X to 3.5X where X is 1 minute to 4 minutes, and is a constant value for each 100% coffee blend
b) is made up of 1 or more streams roasted anywhere From 1X to 3.5X inclusive;
c) these streams are roasted to different or identical roast times and/or different or identical target Hunter L-colors and/or are comprised of different or identical bean types

3. A novel roasted and ground or whole bean coffee product wherein said slower-roast fraction
a) is roasted for a time period of 4.5X to 6X where X is 1 minute to 4 minutes, and is a constant value for each 100% coffee blend
b) is made up of 1 or more streams roasted anywhere from 4.5X to 6X inclusive;
c) these streams are roasted to different or identical roast times and/or different or identical target Hunter L-colors and/or are comprised of different or identical bean types

4. A novel coffee product according to claim 2 wherein the slower-roast fraction and the faster-roast fraction are ground separately.

5. A novel coffee product according to claim 3 wherein the slower-roast fraction and the faster-roast fraction are ground separately.

6. A novel coffee product according to claim 2 wherein the slower-roast fraction and the faster-roast fraction are mixed together after roasting and before grinding.

7. A novel coffee product according to claim 3 wherein the slower-roast fraction and the faster-roast fraction are mixed together after roasting and before grinding.

8. A novel coffee product according to claim 6 except that the coffee mixture is not ground.

9. A novel coffee product according to claim 7 except that the coffee mixture is not ground.

10. A novel coffee product according to claim 2 where any of the slower-roast streams and/or any of the faster-roast streams are mixed together after roasting and before grinding, and the remaining slower-roast streams and/or faster-roast streams are mixed together after grinding.

11. A novel coffee product according to claim 3 where any of the slower-roast streams and/or any of the faster-roast streams are mixed together after roasting and before grinding, and the remaining slower-roast streams and/or faster-roast streams are mixed together after grinding.

12. A novel coffee product according to claim 2 wherein the Hunter L-color of any slower-roast stream is between 2L lighter and 2L darker than any 100% Arabica faster-roast stream.

13. A novel coffee product according to claim 2 wherein the Hunter L-color of any slower-roast stream is between 4L and 7L darker than the target Hunter L-color of each faster-roast coffee stream containing 50% or more Robusta type beans.

14. A novel coffee product according to claim 2 wherein the Hunter L-color of any slower-roast stream is between 2L and 7L darker than the target Hunter L-color of each faster-roast coffee stream containing less than 50% Robusta type beans.

15. A novel coffee product according to claim 3 wherein the Hunter L-color of any slower-roast stream is between 2L lighter and 2L darker than any 100% Arabica faster-roast stream.

16. A novel coffee product according to claim 3 wherein the Hunter L-color of any slower-roast stream is between 4L and 7L darker than the target Hunter L-color of each faster-roast coffee stream containing 50% or more Robusta type beans.

17. A novel coffee product according to claim 3 wherein the Hunter L-color of any slower-roast stream is between 2L and 7L darker than the target Hunter L-color of each faster-roast coffee stream containing less than 50% Robusta type beans.

18. A process for producing a roast coffee blend wherein two coffee bean fractions, each one having been roasted at two or more different roasting speeds, are mixed together.

19. A process according to claim 13 wherein the roast coffee blend comprises one slower-roast coffee bean fraction at a level of from about 20% to about 80% of the coffee blend and one faster-roast coffee bean fraction at a level of from about 20% to about 80% of the coffee blend.

20. A process according to claim 19 wherein the two or more roasted coffee bean fractions are roasted separately and then ground separately.

21. A process according to claim 19 wherein the two or more roasted coffee bean fractions are roasted separately and then ground together.
